(19) United States
(12) Patent Application Publication
(10) Pub. No.: US 2016/0127973 A1
(43) Pub. Date: May 5, 2016

(54) DISPLAY APPARATUS FOR USING NETWORKS AND CONTROL METHOD THEREOF

(71) Applicant: SAMSUNG ELECTRONICS CO., LTD., Suwon-si (KR)

(72) Inventors: Min-suk SEO, Suwon-si (KR); Joo-sun HONG, Suwon-si (KR)

(21) Appl. No.: 14/921,342

(22) Filed: Oct. 23, 2015

(30) Foreign Application Priority Data
Oct. 31, 2014 (KR) 10-2014-0149952

(51) Int. Cl. H04W 36/30; H04W 36/00; H04W 36/14

(52) U.S. Cl. CPC H04W 36/30; H04W 36/14; H04W 36/0088

(57) ABSTRACT

A display apparatus and a control method thereof are provided, wherein the display apparatus receives input of information of a plurality of networks, sets priority information of the plurality of networks, and in response to receving a command to select one of the plurality of networks, measures a signal intensity of the selected network, and when the measured signal intensity is below a preset value, changes to a next-order network from among the plurality of networks based on the priority information.

### CROSS-REFERENCE TO RELATED APPLICATIONS

This application is based on and claims priority under 35 U.S.C. §119 to Korean Patent Application No. 10-2014-0149952, filed on Oct. 31, 2014 in the Korean Intellectual Property Office, the disclosure of which is incorporated by reference herein in its entirety.

### BACKGROUND

1. Field

Apparatuses and methods illustrated in the example embodiments relate to a display apparatus for using networks and a control method thereof, and for example, to a display apparatus which automatically changes to a next-order network, when experiencing difficulty in connecting to a currently-used network, and a control method thereof.

2. Description of Related Art

Advancing electronic technology enabled development and distribution of a variety of display apparatuses. Recently, various types of display apparatus including TVs have been particularly developed for use at homes. These display apparatuses are equipped with more functions to meet increasing user needs. In the case of TV, for example, the TVs are now connectable to the Internet and can provide internet services. The users can also view numerous digital broadcast channels on TV.

Accordingly, various network settings are required for more efficient use of the internet services on the display apparatuses. For example, wired LAN or wireless LAN may be used to provide the internet services on the display apparatus, and the users can choose any of the wired and wireless networks to access the Internet.

However, there is a shortcoming. That is, the display apparatus may experience difficulty in connecting to the Internet during use of the internet service, due to changes in the network environment or internal issues occurring on the side of the service provider. If a user experiences difficulty of using the currently-used network due to, for example, abrupt weather change during use of the internet service of the display apparatus, the user has to go to the initial network setting stage and select an alternative network service, which can be quite cumbersome.

### SUMMARY

Example embodiments of the disclosure overcome the above disadvantages and other disadvantages not described above.

According to an example embodiment, a display apparatus which automatically changes to a next-order network, when experiencing difficulty in connecting to a network in use, e.g., a currently-used or selected network, is provided.

According to an example embodiment, a method of controlling a display apparatus is provided, which may include receiving information of a plurality of networks, setting priority information of the plurality of networks, in response to receiving a command to select one of the plurality of networks, measuring a signal intensity of the selected network, and when the measured signal intensity is below a preset value, changing to a next-order network among the plurality of networks based on the priority information.

The control method may additionally include, after changing to the next-order network, re-measuring the signal intensity of the user-selected network periodically, and when the signal intensity of the user-selected network is equal to or greater than the preset value, changing from the next-order network to the user-selected network.

The method may include, after changing to the next-order network, measuring or determining the signal intensity of the next-order network, and when the signal intensity of the next-order network is below the preset value, changing to another network other than the next-order network among the plurality of networks based on the priority information.

Setting may include setting the priority information of the plurality of networks based on the network signal intensities.

Setting may include re-measuring the signal intensity of the network periodically and changing the priority information, when the priority information is set to be network signal intensity information.

Setting may include setting the priority information of the plurality of networks using at least one of network charge information, content-based network capacity and speed, and network use frequency.

The plurality of networks may include at least one of a wired network, a wireless network and a mobile network.

Changing may additionally include displaying a message informing that the network has been changed to the next-order network.

In an example embodiment, a display apparatus, which may include input circuitry configured to receive information of a plurality of networks and to set priority information of the plurality of networks, an intensity measuring circuit configured to measure signal intensity of a selected network, when a user command to select one among the plurality of networks is received, and a controller configured to change to a next-order network among the plurality of networks based on the priority information, when the measured signal intensity is below a preset value.

After changing to the next-order network, the controller may be configured to control the intensity measuring circuit to re-measure the signal intensity of the selected network periodically, and when the signal intensity of the user-selected network is equal to or greater than the preset value, to change from the next-order network back to the selected network.

After changing to the next-order network, the controller may be configured to control the intensity measuring circuit to measure the signal intensity of the next-order network, and when the signal intensity of the next-order network is below the preset value, to change to another network other than the next-order network among the plurality of networks based on the priority information.

The controller may be configured to set the priority information of the plurality of networks based on the received network signal intensities.

The controller may be configured to control the intensity measuring circuity to re-measure the signal intensity of the network periodically and to change the priority information, when the priority information is set to be network signal intensity information.

The controller may be configured to set the priority information of the plurality of networks using at least one of network charge information, content-based network capacity and speed, and network use frequency.

The plurality of networks may include at least one of a wired network, a wireless network and a mobile network.

The display apparatus may additionally include a display configured to display a message informing that the network has been changed to the next-order network.

According to various example embodiments, the display apparatus is more convenient and efficient to control as it automatically changes a currently-used network to a next-order network when experiencing difficulty in connecting to the currently-used network.

According to various example embodiments, it is possible to control a display apparatus to automatically change to a next-order network when experiencing difficulty in connecting to a currently-used network.

### BRIEF DESCRIPTION OF THE DRAWINGS

The above and/or other aspects and advantages of the disclosure will become more apparent with reference to the following detailed description, taken in conjunction with the accompanying drawings, in which like reference numerals refer to like elements, and wherein:

FIG. 1 is a block diagram illustrating a display apparatus according to an example embodiment;

FIG. 2 is a block diagram illustrating a display apparatus according to an example embodiment;

FIG. 3 is a view illustrating a process of measuring a network intensity, according to an example embodiment;

FIG. 4 is a table illustrating a process of measuring a network intensity, according to an example embodiment;

FIGS. 5A to 5C are views illustrating a process of setting a network of a display apparatus, according to an example embodiment;

FIGS. 6A to 6D are views illustrating a process of setting content-based network priority information, according to an example embodiment;

FIGS. 7A and 7B are views illustrating an operation of displaying user OSD on a display apparatus screen regarding whether or not to change a network;

FIGS. 8A and 8B are views illustrating an operation of displaying an OSD on a display apparatus screen regarding downloading of a movie and changing the network according to an example embodiment.

FIG. 9 is a flowchart illustrating a process of setting a network of a display apparatus, according to an example embodiment; and

FIG. 10 is a flowchart illustrating a process of setting a network of a display apparatus, according to an example embodiment.

### DETAILED DESCRIPTION

Certain example embodiments will now be described in greater detail with reference to the accompanying drawings.

In the following description, same drawing reference numerals are used for the same elements even in different drawings. The matters defined in the disclosure, such as detailed construction and elements, are provided to assist in understanding of the disclosure. Accordingly, it is apparent that the example embodiments can be carried out without those specifically defined matters. Also, well-known functions or constructions are not described in detail since they might obscure the disclosure with unnecessary detail.

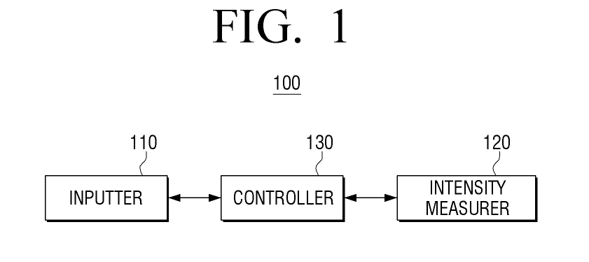

FIG. 1 is a block diagram illustrating a display apparatus. As illustrated in FIG. 1, the display apparatus 100 may include a user inputter in the form of input circuitry 110, an intensity measurer or intensity measuring circuit 120 and a controller 130. The display apparatus 100 may, for example, be a smart TV, but this is provided only as an example and the display apparatus 100 may be implemented as a digital TV, a desktop PC, a laptop PC, a variety of other display apparatuses, etc.

The user inputter or input circuitry 110 receives various commands to control the display apparatus 100. The inputter 110 may be implemented as a button, but example embodiments are not limited thereto. Accordingly, the inputter 100 may be a remote controller, a touch screen, a voice recognizer, a pointing device, or a variety of other input devices.

For example, the inputter 110 may receive an input of information about a plurality of networks which can be currently used by the display apparatus 100, and receive an input of a user command to set priority information. According to an example embodiment, the inputter 110 may receive information about a plurality of networks and then receive a command to set the priority information about the plurality of networks based on input network signal intensities. Further, the inputter 110 may receive a command setting the priority information about the plurality of networks, using at least one of network charge information, content-based network capacity and speed, and frequency of network use by the user.

The inputter 110 may be integrated with the display apparatus 100, or implemented as a separate part. When provided as a separate part, the inputter 110 may be connected to the display apparatus 100 via network. Further, the inputter 110 may be implemented as a button, but example embodiments are not limited thereto. Accordingly, the inputter 110 may be implemented as a remote controller, a touch screen, a voice recognizer, a pointing device, or a variety of other input devices.

The intensity measuring circuit 120 may measure the signal intensity within a currently-connected network and provide the result to the controller 130 which will be described below. Specifically, the intensity measuring circuit 120 may receive information about a plurality of networks through the inputter 110 and measure the intensities of the plurality of networks. Further, in response to a command selecting one of the plurality of networks, the intensity measuring circuit 120 may measure the intensity of the signal regarding the selected network. This will be explained in detail below.

The controller 130 may be configured to control the overall operation of the display apparatus 100.

For example, in an example embodiment, the controller 130 may be configured to receive information about a plurality of networks and a command setting the priority information of the plurality of networks, through, for example, the inputter 110. The priority information of the plurality of networks may be set based on the network signal intensities which may also be input. The controller 130 may also be configured to change the network intensity-based priority information, by controlling the intensity measuring circuity 120 to re-measure the signal intensities of the networks periodically.

The priority information of the plurality of networks may also be set using at least one of network charge information, content-based network capacity and speed, and network use frequency, for example, as set by the user.

According to an example embodiment, the controller 130 may be configured to receive through the inputter 110 a command to select one of the plurality of networks. At this time, the controller 130 may be configured to control the intensity measuring circuity 120 to measure the signal intensity of the network selected through the inputter 110. For example, when the signal intensity of the selected network is below a preset value, the controller 130 may be configured to change to a next-order network among the plurality of networks based on the priority information.

After changing to the next-order network, the controller 130 may be configured to control the intensity measuring circuit 120 to re-measure the signal intensity of the selected network periodically. When the signal intensity of the network selected through the inputter 110 is equal to or greater than a preset value, the controller 130 may be configured to change back to the selected network from the next-order network.

According to an example embodiment, as described above, when the signal intensity of the selected network is below the preset value, the controller 130 may be configured to change from the selected network to the next-order network. The controller 130 may be configured to control the intensity measuring circuit 120 to re-measure the signal intensity of the next-order network and when the signal intensity of the next-order network is below the preset value, may change from the next-order network to another network other than the next-order network based on the priority information of the plurality of networks.

According to an example embodiment, a plurality of networks may include at least one of wired network, wireless network and mobile network.

The controller 130 may also be configured to control the display to display a message informing that a change in network has occurred.

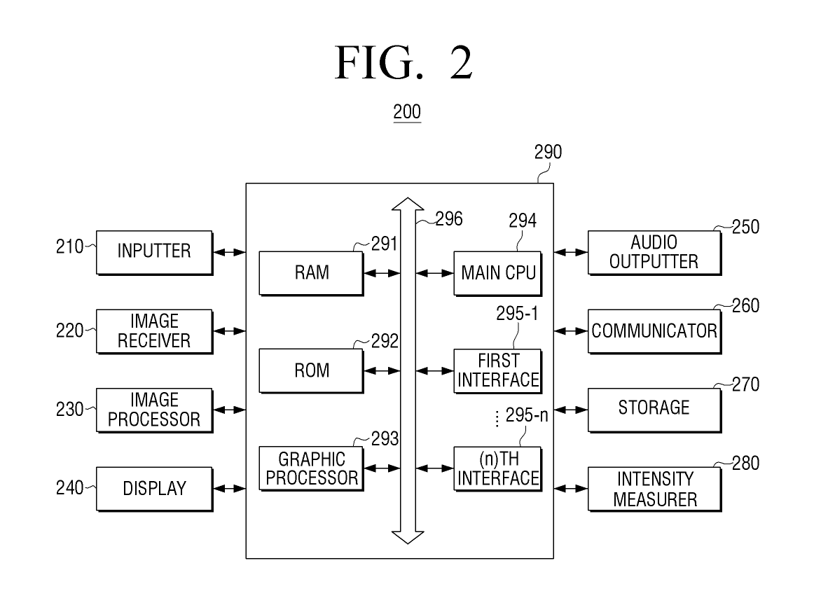

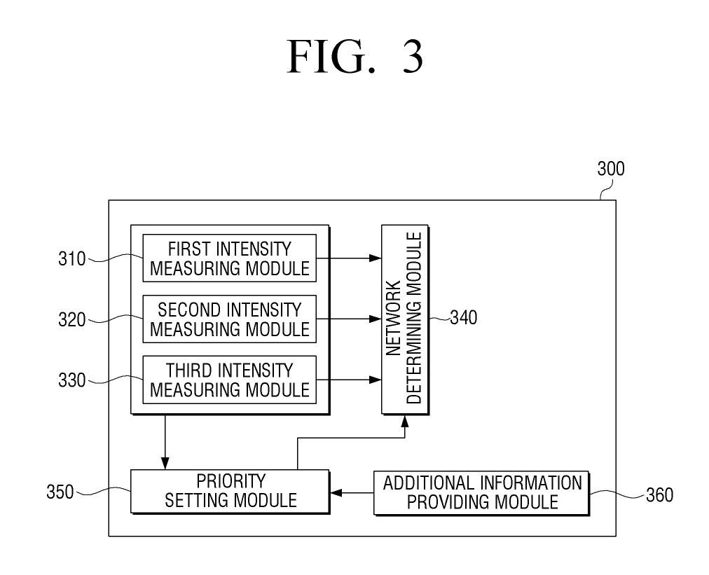

A display apparatus 200 according to various example embodiments will be explained with reference to FIGS. 2 to 7C.

FIG. 2 is a detailed block diagram of a display apparatus 200 according to an example embodiment. As illustrated in FIG. 2, the display apparatus 200 may include an inputter in the form of input circuitry 210, an image receiver 220, an image processor 230, a display 240, an audio ouputter or output circuitry 250, a communicator or communication circuitry 260, a storage 260, an intensity measuring circuit 280, and a controller 290.

FIG. 2 illustrates an example structure integrating therein a variety of components providing a variety of functions including displaying, multi-view function, communication function, or image receiving function. It is of course possible that, depending on embodiments, some constituent elements may be omitted or modified, or other constituent elements may be added.

The inputter 210 receives various commands to control the display apparatus 200. The inputter 210 may, for example, be implemented as buttons, but example embodiments are not limited thereto. Accordingly, the inputter 210 may be implemented as a remote controller, a touch screen, a voice recognizer, a pointing device, or various other input devices.

For example, the inputter 210 may receive information about a plurality of networks which can be currently used by the display apparatus 200, and receive a user command to set the priority information of the plurality of networks. For example, after inputting the wired network information, wireless network information and mobile network information through the inputter 210, priority information about three networks may be input based on the signal intensities of the three input networks. For example, when the signal intensities are in the order of wired network>wireless network> mobile network, a selection of the wired network as the priority #1 network may be input and then the priority information for the wireless network and the mobile network may be input in order.

According to an example embodiment, the inputter 210 may receive priority information of the plurality of networks, using at least one of the network charge information, content-based network capacity and speed, and user's network use frequency. For example, to use Ka***talk content, a mobile network with relatively lower network capacity and speed may be input as the priority #1 network. To download a movie, the wired network with relatively larger network capacity and speed, may be input as the priority #1 network.

As described, the inputter 210 may be integrated with the display apparatus 100 or provided as a separate part. The inputter 210 as the separated part may be connected to the display apparatus 100 via the network. Further, the inputter 210 may be implemented as buttons, but example embodiments are not limited thereto. Accordingly, the inputter 210 may be implemented as a remote controller, a touch screen, a voice recognizer, a pointing device, or various other input devices.

The image receiver 220 receives image content from a variety of external sources. For example, the image receiver 220 may receive broadcast content from an external broadcast station, receive image content from an external device (e.g., DVD, settop box, etc.), and receive streaming content from an external server. For example, the image receiver 220 may receive a variety of contents by connecting via a mobile network, or wired/wireless network.

The image processor 230 is configured to process the image content received at the image receiver 220 into data in a displayable form. For example, the image processor 230 may be configured to include a plurality of image processing modules to operate in a plurality of modes.

The display 240 displays the image content processed by the image processor 230, under control of the controller 290. For example, the display 240 may display an OSD as a guide, when it receives information of a plurality of networks for the purpose of initial network setting of the display apparatus 200. For example, after information of a plurality of networks is input through the inputter 210, in response to inputting of a command directing to select one of the plurality of networks, the controller 290 may be configured to measure the user-selected intensity through the intensity measuring circuit 280 and display, through the display 240, a priority list regarding the intensities of the plurality of networks. Further, when the network selected through the inputter 210 is changed to a next-order network, the display 240 may display an OSD to inform that the selected network has been changed to the next-order network. This will be described in detail below.

The audio output circuit or outputter 250 outputs audio data of the image content. For example, when the display apparatus 200 displays a plurality of contents, the audio outputter 250 may output a portion of the audio data of the plurality of contents through a speaker, and output the rest of the audio data of the plurality of contents to an external audio playback apparatus (e.g., earphone, headphone, etc.) in a wired/wireless manner.

The communicator or communication circuitry 260 is configured to perform communication with various types of external devices by various types of communication methods. In an example embodiment, the communicator or communication circuitry 260 performs communication in wired network, wireless network and mobile network manner.

For example, the communicator or communication circuitry 260 may include a variety of communication chips such as WiFi chip, Bluetooth chip, NFC chip, wireless communication chip, or the like. The WiFi chip, Bluetooth chip and NFC chip perform communication in WiFimanner, Bluetooth manner and NFC manner, respectively. The “NFC chip” used herein refers to a chip operating in a near field communication (NFC) manner using, for example, 13.56 MHz band among various RF-ID frequency bands of 135 kHz, 13.56 MHz, 433 MHz, 860-960 MHz, 2.45 GHz, etc. When a WiFi chip or Bluetooth chip is used, various connection-related information such as SSID and session key may be transmitted and received first, so that communication is connected using these information before desired information is transmitted and received. The “wireless communication chip” as used herein refers to a chip which performs communication under various communication standards including, for example, IEEE, Zigbee, 3rd generation (3G), 3rd generation partnership project (3GPP), long term evolution (LTE), etc.

Further, as described above, the communicator or communication circuitry 260 may be not only an NFC communication module for wireless LAN communication, but may also be a 3G communication network capable of mobile communication. For example, the communicator or communication circuitry 260 may perform 3G communication including, for example, CDMA, WCDMA, global system for mobile communication (GSM), evolved packet core (EPC) or long term evolution (LTE).

The storage 270 stores various modules to drive the display apparatus 200. For example, the storage 270 may store software including a base module, a sensing module, a communication module, a presentation module, a web browser module, and a service module. The “base module” as used herein refers to a basic module which processes signals transmitted from respective hardware included in the display apparatus 200 and transmits the same to the upper layer modules. The “sensing module” as used herein refers to a module which collects information from various sensors and analyzes and manages the collected information, and may include a facial recognition module, a voice recognition module or an NFC recognition module. The “presentation module” as used herein refers to a module which configures a display screen, and may include a multimedia module to playback and output multimedia content, or an OSD rendering module to process OSD and graphics. The “communication module” as used herein refers to a module to perform communication with outside. The “web browser module” as used herein refers to a module which performs web browsing and accesses the web server. The “service module” as used herein refers to a module which includes various applications to provide various services.

Further, according to an example embodiment, the storage 270 may store network priority information (e.g., network charge information, content-based network capacity and speed, or user's network use frequency).

As described above, the storage 270 may include various program modules, but is not limited thereto. Accordingly, some program modules may be omitted, modified or added depending on types and characteristics of the display apparatus 200. For example, when the display apparatus 200 is implemented as a tablet PC, the base module may additionally include a position determining module to determine GPS-based position and the sensing module may additionally include a sensing module to sense user movement.

The intensity measuring circuit 280 measures signal intensity within the currently-connected network and provides the result to the controller 130 which will be described below. For example, the intensity measuring circuit 280 may receive information of a plurality of networks and a command to set priority information of the networks, through the inputter 210. In response to inputting of a command directing selection of one of the plurality of networks, the intensity measuring circuit 280 may measure the signal intensity of the selected network. That is, the intensity measuring circuit 280 may be configured as one single part to measure the intensities of the plurality of input networks, or alternatively, may include an Ethernet physical layer (not shown) to measure wired network intensity, a WiFi module (not shown) to measure wireless network intensity, and a 3G/4G dongle (not shown) to measure mobile network intensity, to thus measure the intensities of a plurality of networks.

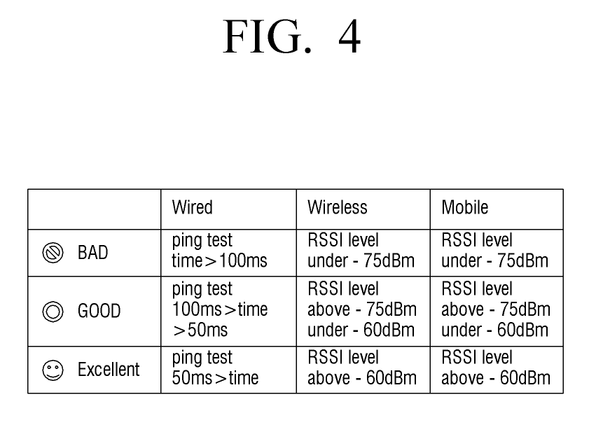

According to an example embodiment, the intensity measuring circuity 280 may measure intensities of the respective networks using a physical test which measures intensities of a plurality of networks inputted through the inputter 210. For example, as illustrated in FIG. 4, taking a wired network for example, the intensity measuring circuit 280 as illustrated in FIG. 2 may measure the signal intensity of the wired network by measuring the duration of time for a ping test. For example, the signal intensity may be determined to be “Bad” when Ping Test Time>100 ms, determined to be “Good” when Ping Test 100 ms>Time>50 ms, and determined to be “Excellent” when Ping Test 50 ms>Time. For wireless network and mobile network, for example, the intensity measuring circuit 280 in FIG. 2 may measure signal intensities of the wireless network and mobile network by measuring signal intensity (e.g., RSSI level) received at an antenna. For example, the signal intensity may be determined to be “Bad” when RSSI Level under −75 dBm, determined to be “Good” when RSSI Level above −75 dBm under −60 dBm, and determined to be “Excellent” when RSSI Level above −60 dBm.

Meanwhile, in the example embodiments described above, the signal intensities may be determined based on the reference values of ‘Ping Test: 100 ms, 50 ms/RSSI level: −75 dBm, −60 dBm, but example embodiments are not limited thereto. Accordingly, various other reference values may be set.

Further, the signal intensity measurement of the wired network, wireless network and mobile network may be conducted with various other methods, without being limited to the example embodiment described above in which the ping test and RSSI levels are used.

The controller 290 may be configured to control the overall operation of the display apparatus 200 using various stored programs and information.

As illustrated in FIG. 2, the controller may include a RAM 291, a ROM 282, a graphic processor 293, a main CPU 294, a first to (n)th interfaces 295-1 to 295-n, and a bus 296. The RAM 291, the ROM 282, the graphic processor 293, the main CPU 294, and the first to (n)th interfaces 295-1 to 295-n may be connected to each other via the bus 296.

The ROM 292 stores a command set for system booting, for example. For example, with the power supplied according to turn-on command, the main CPU 294 copies the O/S stored at the storage 270 onto the RAM 291 and executes the O/S to boot the system. As the booting is completed, the main CPU 294 copies the application programs stored at the storage 270 onto the RAM 291 and performs various operations by executing the application programs copied on the RAM 291.

The graphic processor 293 generates a screen including various objects including an icon, an image or a text, using an arithmetic operator (not illustrated), and a renderer (not illustrated). Using the control command received at the inputter 210, the arithmetic operator obtains by arithmetic operation the attribute values such as coordinate values, shapes, sizes, or colors with which the respective objects are to be displayed according to the layout of the screen. The renderer generates a screen in various layouts including the objects, based on the attributes values obtained at the arithmetic operator. The screen generated at the renderer is displayed within a display area of the display 240.

The main CPU 294 accesses the storage 270 and performs booting using the OS stored at the storage 270. The main CPU 294 then performs various operations using the various programs, contents or data stored at the storage 270.

The first to the (n)th interfaces 295-1 to 295-n are connected to the respective constituent elements described above. One of the interfaces may become a network interface which is connected to an external device via a network.

Specifically, the controller 290 may be configured to receive information of a plurality of networks through the inputter 210 and set the priority information of the plurality of networks. At this time, the priority information of the plurality of networks may be set based on the network signal intensities, or based on set priority information (e.g., at least one of network charge information, content-based network capacity and speed, and user's network use frequency).

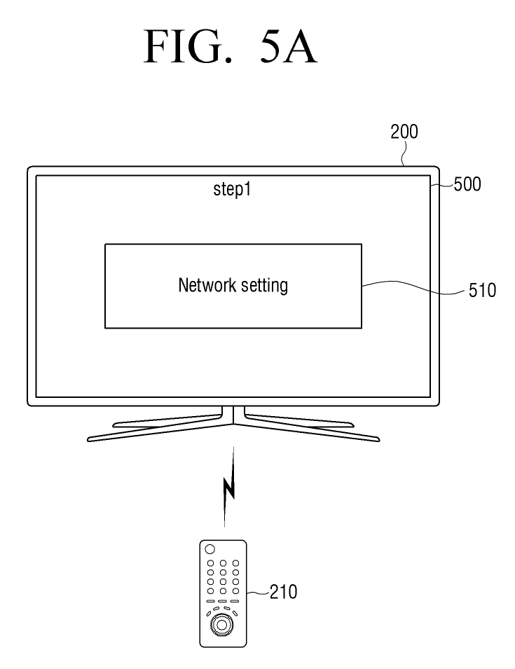

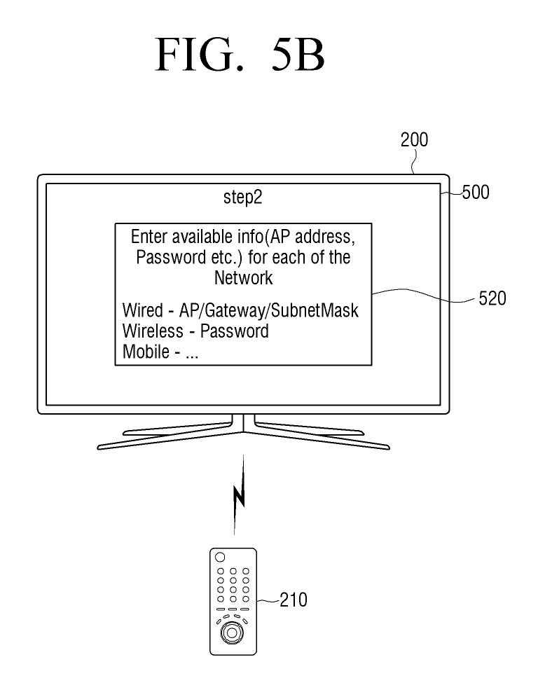

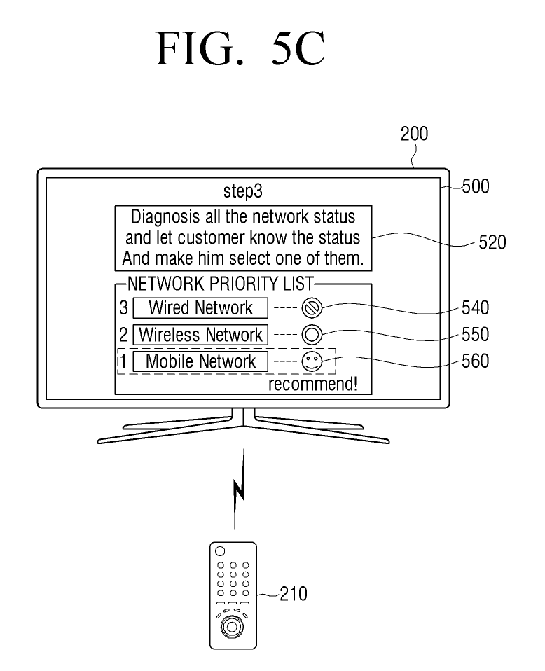

Further, in response to inputting of a command to select one of the plurality of networks, the controller 290 may be configured to control the intensity measuring circuit 280 to measure the signal intensity of the selected network. At this time, when the measured signal intensity is below a preset value, the controller 290 may be configured to change to a next-order network of the plurality of network based on the priority information. This will be explained below by referring to various embodiments and FIGS. 5A to 7C.

As illustrated in FIGS. 5A-5C, according to an example embodiment, the user may enter network initial setting operation 510 of the display apparatus 200 after which the user may input wired network information, wireless network information and mobile network information through the inputter 210 as illustrated, for example, in FIG. 5B. At this time, the controller 290 may set the priority information of the plurality of networks based on the signal intensities of the plurality of networks as inputted. Specifically, as illustrated in FIG. 5C and by referring to the table of FIG. 4, the controller 290 may be configured to determine the wired network signal to be “Bad” when the wired network intensity as measured through the intensity measuring circuity 280 is Ping Test time>100 ms. The controller 290 may be configured to determine the wireless network signal to be “Good” when the wireless network intensity is RSSI Level: −65 dBm, or determine the mobile network signal to be “Excellent” when the mobile network intensity is RSSI Level: −50 dBm. At this time, the controller 290 may determine the priority information according to the signal intensities of the plurality of networks in the order of: 1. Mobile network; 2. Wireless network; 3. Wired network, and display an OSD 520 recommending the mobile network with the strongest signals.

According to an example embodiment, referring to FIG. 5C, in response to inputting of a user command by the user through the inputter 210 to select one of the plurality of networks, the controller 290 may be configured to control the intensity measuring circuit 280 to measure signal intensity of the selected network. When the measured signal intensity is below a preset value, the controller 290 may be configured to change to a next-order network of the plurality of networks based on the priority information. For example, after in input is received through the inputter 210 a command to select a mobile network, when the intensity measuring circuity 280 measures the mobile network to be RSSI Level under −75 dBm, the controller 290 may be configured to determine the signal intensity to be “Bad” and change to the next-order network, e.g., to the wireless network. The reference value to determine need to change to the next-order network may be set to a value at which the status turns to “Bad” (e.g., RSSI Level under −75 dBm), as described above in the example embodiment. However, example embodiments are not limited to the specific example only. Accordingly, the reference value may be set to a value at which the status turns to “Good” (e.g., RSSI Level above −75 dBm under −60 dBm).

In an example embodiment, the controller 290 may be configured to control the intensity measuring circuit 280 to re-measure the signal intensity of the selected network periodically, after the selected network is changed to the next-order network. For example, when the signal intensity of the selected network is equal to or greater than the preset value, the controller 290 may be configured to change from the next-order network back to the selected network. For example, referring to FIG. 4, when the user-selected network (i.e., mobile network) has the RSSI level “under −75 dBm” (i.e., signal status: Bad), the controller 290 may be configured to change from the mobile network to a wireless network. While the wireless network is in use, the mobile network intensity may be periodically re-measured so that the controller 290 may be configured to change from the wireless network back to the mobile network when the mobile network intensity is RSSI Level is above −60 dBm (signal status: Excellent).

According to an example embodiment, after changing to the next-order network, the controller 290 may be configured to control the intensity measuring circuit 280 to measure the signal intensity of the next-order network in a real-time basis. For example, when the signal intensity of the next-order network is below the preset value, the controller 290 may be configured to change to another network other than the next-order network from among the plurality of networks based on the priority information. For example, referring to FIG. 4, when the selected network (i.e., mobile network) has the RSSI level under −75 dBm, the controller 290 may be configured to change from the mobile network to the wireless network. When the wireless network intensity is RSSI Level under −75 dBm, the controller 290 may be configured change from the next-order network (i.e., wireless network) to another network other than the next-order network (i.e., wired network).

According to an example embodiment, the priority information may be set based on the network signal intensity information, in which case the controller 290 may be configured to re-measure the intensities of the plurality of networks periodically and change the network priority information as illustrated in FIG. 5C on a real-time basis. Further, when there is a change in the priority information according to the network signal intensity, the controller 290 may be configured to display an OSD indicating the change in the priority information.

An example embodiment is described above, in which the controller 290 is configured to set the priority information based on the intensity information of the plurality of networks as measured through the intensity measuring circuit 280. However, example embodiments are not limited to any specific example. Accordingly, the priority information may be set, using at least one of network charge information, content-based network capacity and speed, and user's network use frequency.

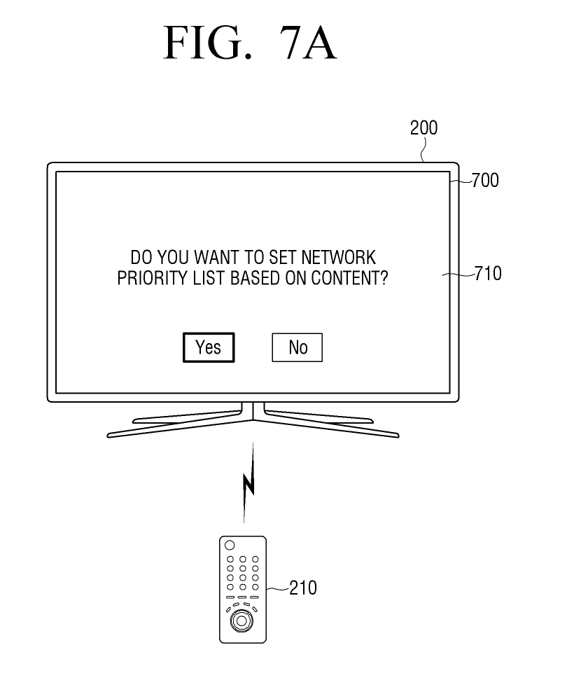

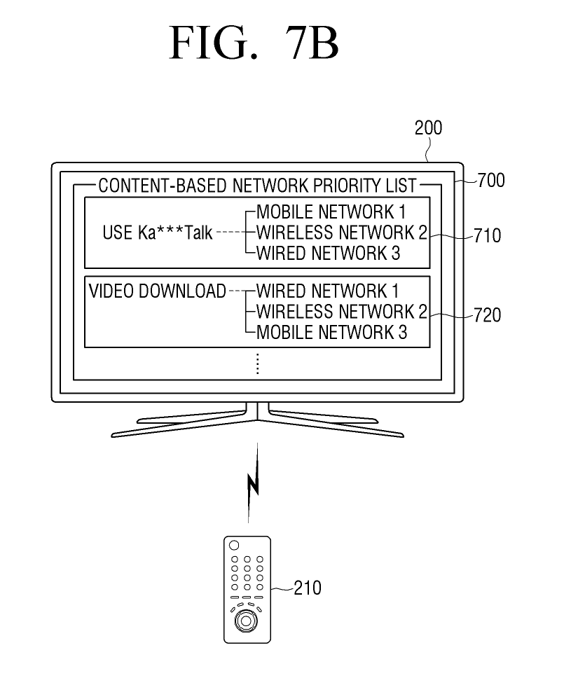

According to an example embodiment, referring to FIG. 7A, the controller 290 may be configured to display an OSD 710 such as “Do you want to set a content-based network priority list?’ during initial network setting of the display apparatus 200. In response to inputting of “Yes” through the inputter 210, the controller 290 may be configured to set the priority of the plurality of networks using the content-based network capacities and speeds as stored at the storage 270, and display the result. For example, referring to FIG. 7B, to use a Ka***Talk which needs relatively low network capacity and speed, the controller 290 may be configured to set the network priority as: 1. Mobile network; 2. Wireless network; 3. Wired network, and display a related OSD. Meanwhile, to download video which requires relatively high network capacity and speed, the controller 290 may be configured to set the network priority as: 1. Wired network; 2. Wireless network; 3. Mobile network, and display a related OSD.

According to the example embodiment as described above, the plurality of networks may include at least one of wired network, wireless network and mobile network, which may be input in various manners.

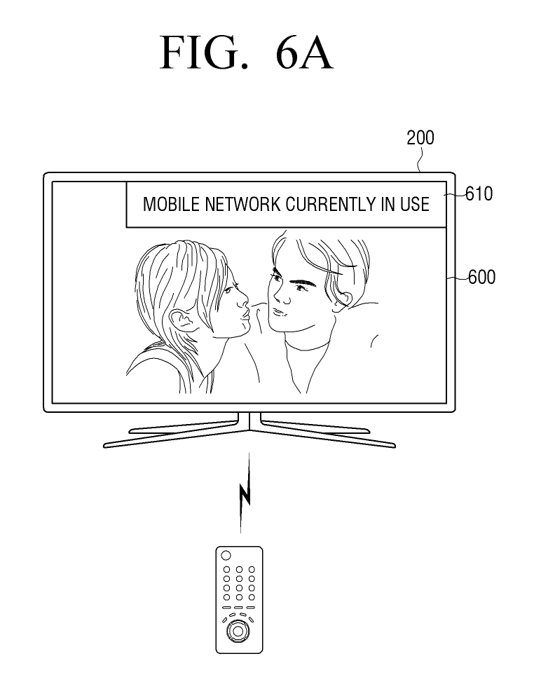

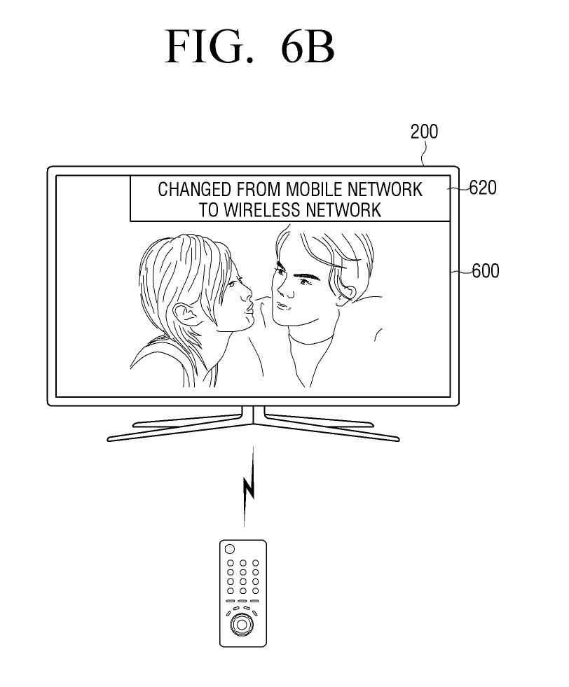

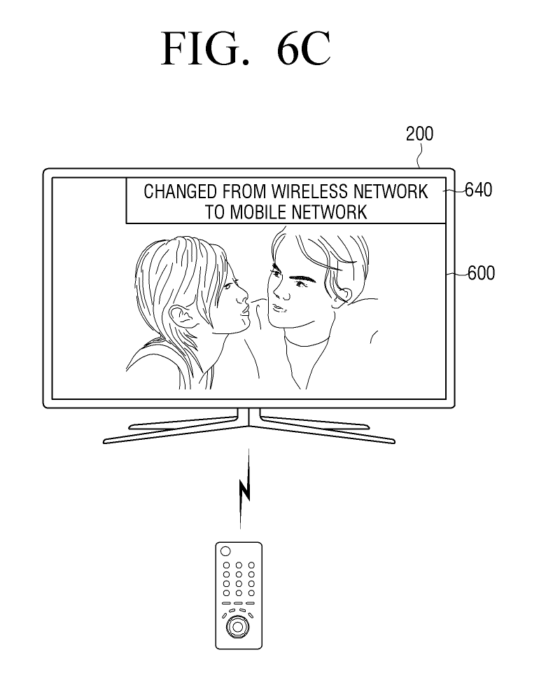

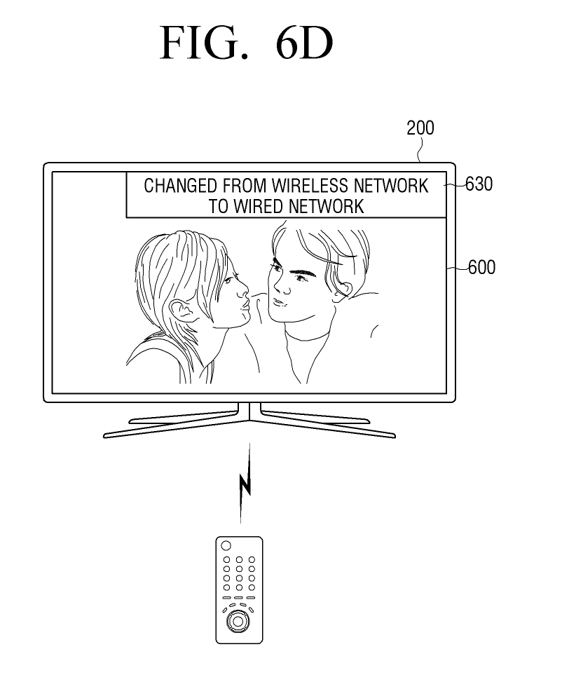

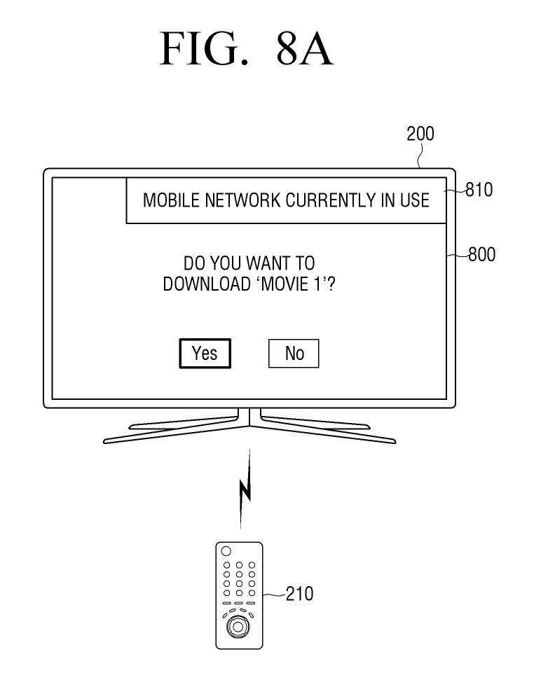

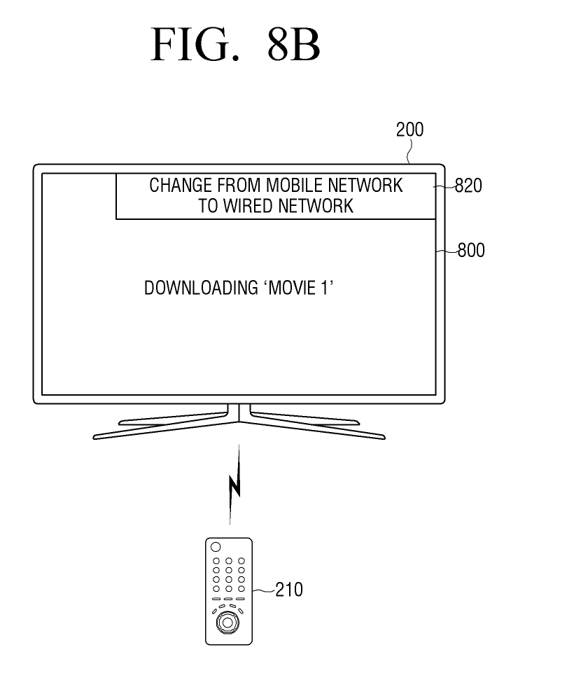

According to the example embodiment as described above, referring to FIGS. 6B-6D. 7A, when the network is changed from the user-selected network to the next-order network, the controller 290 may be configured to display a message 620, 630, 640, for example, informing such change of the network. Further, the content-based network capacity and speed may be set during the initial network setting of the display apparatus 200, in which case the controller 290 may be configured to display an OSD to inform it when the content-based network is changed. For example, referring to FIGS. 8A-8B, the user may want “Download Movie 1” while using the mobile network, in which case the controller 290 may be configured to display a user OSD 820 during video downloading, thus informing that the mobile network is changed to the wired network, based on the network priority information (see FIG. 5C, 1. Wired network; 2. Wireless network; 3. Mobile network).

According to an example embodiment, when the next-order network is changed to another network, and when there is a change in the network priority information based on real-time intensity measurement, the controller 290 may be configured to display a message informing that the currently-used network is changed.

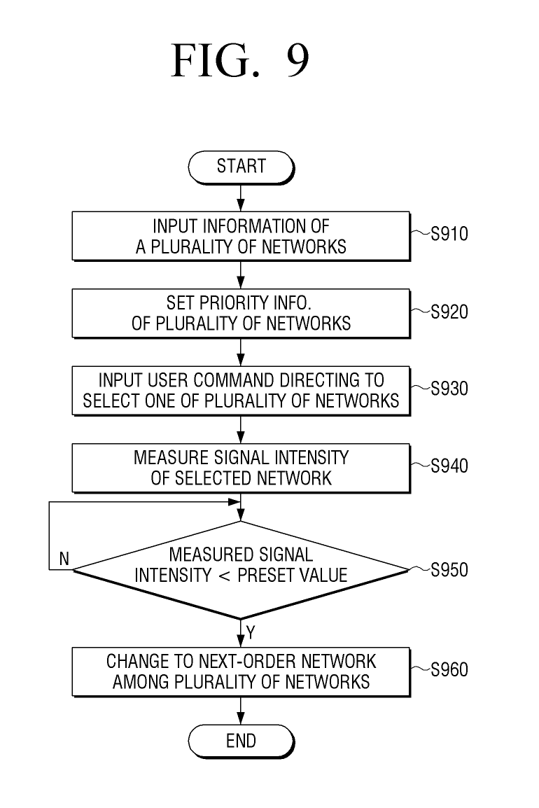

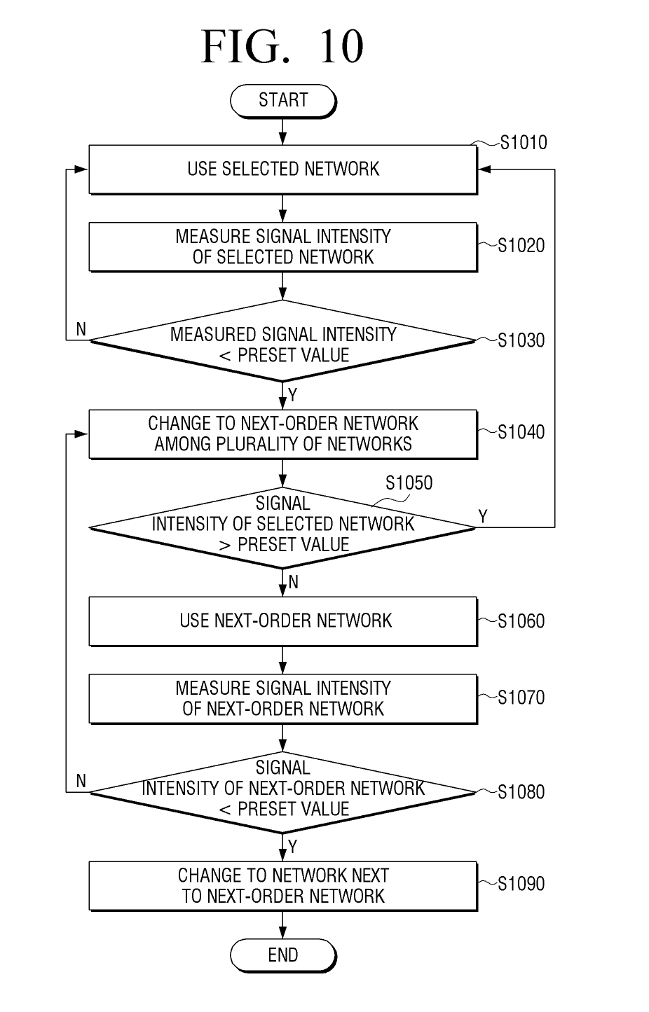

Various example embodiments will be explained with reference to FIGS. 9 and 10 which are flowcharts illustrating a control method of the display apparatus 100 for automatically changing to a next-order network when experiencing a difficulty in connecting to the network in use.

FIG. 9 is a flowchart provided to illustrate setting a network of a display apparatus, according to an example embodiment.

First, the display apparatus 100 receives information of a plurality of networks, at S910. At this time, the display apparatus 100 may receive information about wired network, wireless network and mobile network, but example embodiments are not limited thereto. Accordingly, information about various networks may be received.

The display apparatus 100 may set priority information of the plurality of networks, at S920. At this time, the priority information of the networks may be set based on the network signal intensities as input. Alternatively, the network priority information may be set using at least one of the network charge information, content-based network capacity and speed, and user's network use frequency.

The display apparatus 100 receives a command to select one of the plurality of networks, at S930.

Next, the display apparatus 100 measures intensity of the signal of the selected network, at S940. According to an example embodiment, the intensity of the wired network may, for example, be measured based on the duration of time for the ping test, and the wireless network and the mobile network may be measured based, for example, on the RSSI levels.

When the signal intensity of the selected network is below a preset value, at S950-Y, the display apparatus 100 changes to a next-order network among the plurality of networks, at S960. For example, referring to FIG. 5C, a command to select the mobile network may be input through the inputter 210 and when the mobile network is measured to be “RSSI Level under −75 dBm” by the intensity measuring circuit 280, the controller 290 may be configured to determine the signal intensity to be “Bad” and change to a next-order network (i.e., wireless network). At this time, the reference value to determine need to change to the next-order network may be set to a value at which the status turns to “Bad” (e.g., RSSI Level under −75 dBm), as described above in the example embodiment. However, example embodiments are not limited to the specific example only. Accordingly, the reference value may be set to a value at which the status turns to “Good” (e.g., RSSI Level above −75 dBm under −60 dBm).

Unless the selected network has a signal intensity below the preset value, at S950-N, the display apparatus 100 may keep using the user-selected network.

FIG. 10 is a flowchart provided to illustrate a process of setting a network of a display apparatus, according to an example embodiment.

First, the display apparatus 100 uses a selected network, at S1010.

The display apparatus 100 may then measure the signal intensity of the selected network, at S1020.

When the signal intensity of the user-selected network is below the preset value, at S1030-Y, the display apparatus 100 changes to a next-order network among the plurality of networks, at S1040.

Meanwhile, the display apparatus 100 may keep using the selected network, unless the signal intensity of the user-selected network is below the preset value, at S1030-N.

The display apparatus 100 may change from the next-order network to the selected network when the signal intensity of the selected network is equal to or greater than the preset value, at S1050-Y.

The display apparatus 100 may keep using the next-order network unless the signal intensity of the selected network is equal to or greater than the preset value, at S1050-N.

The display apparatus 100 may measure the signal intensity of the next-order network again, at S1070.

When the signal intensity of the next-order network is below the preset value, at S1080-Y, the display apparatus 100 changes to a network next to the next-order network, among the plurality of networks, at S1090.

According to various example embodiments including those described above, the display apparatus is more convenient and efficient to control as it automatically changes a currently-used network to a next-order network when experiencing difficulty in connecting to the currently-used network.

A program code to perform a control method of a display apparatus according to various example embodiments including those described above, may be stored on a non-transitory computer readable medium. The “non-transitory computer readable medium” as used herein refers to a medium which is capable of semi-permanently storing data and can be read by a device, rather than a medium such as register, cache, or memory which stores data for a brief period of time. Specifically, various applications or programs described above may be stored and provided on the non-transitory computer readable medium such as CD, DVD, hard disk, blu-ray disk, USB, memory card or ROM. For example, as described above, and will be appreciated by those skilled in the art, the described systems, methods and techniques may be implemented in digital electronic circuitry including, for example, electrical circuitry, logic circuitry, hardware, computer hardware, firmware, software, or any combinations of these elements. Apparatus embodying these techniques may include appropriate input and output devices, a computer processor, and a computer program product tangibly embodied in a non-transitory machine-readable storage device or medium for execution by a programmable processor. A process embodying these techniques may be performed by a programmable hardware processor executing a suitable program of instructions to perform desired functions by operating on input data and generating appropriate output. The techniques may be implemented in one or more computer programs that are executable on a programmable processing system including at least one programmable processor coupled to receive data and instructions from, and transmit data and instructions to, a data storage system, at least one input device, and at least one output device. Each computer program may be implemented in a high-level procedural or object-oriented programming language or in assembly or machine language, if desired; and in any case, the language may be compiled or interpreted language. Suitable processors include, by way of example, both general and special purpose microprocessors. Generally, a processor will receive instructions and data from a read-only memory and/or a random access memory. Non-transitory storage devices suitable for tangibly embodying computer program instructions and data include all forms of computer memory including, but not limited to, non-volatile memory, including by way of example, semiconductor memory devices, such as Erasable Programmable Read-Only Memory (EPROM), Electrically Erasable Programmable Read-Only Memory (EEPROM), and flash memory devices; magnetic disks, such as internal hard disks and removable disks; magneto-optical disks; Compact Disc Read-Only Memory (CD-ROM), digital versatile disk (DVD), Blu-ray disk, universal serial bus (USB) device, memory card, or the like. Any of the foregoing may be supplemented by, or incorporated in, specially designed hardware or circuitry including, for example, application-specific integrated circuits (ASICs) and digital electronic circuitry. Thus, methods for providing image contents described above may be implemented by a program including an executable algorithm that may be executed in a computer, and the program may be stored and provided in a non-transitory computer readable medium.

Further, the foregoing example embodiments and advantages are merely examples and are not to be construed as limiting the example embodiments. The disclosure can be readily applied to other types of apparatuses. Also, the description of the example embodiments is intended to be illustrative, and not to limit the scope of the claims.

What is claimed is:

1. A method of controlling a display apparatus, comprising:
receiving information of a plurality of networks;
setting priority information of the plurality of networks;
measuring a signal intensity of the selected network in response to receiving a command to select one of the plurality of networks; and
changing the selected network to a next-order network from among the plurality of networks based on the priority information when the measured signal intensity is below a preset value.

2. The method of claim 1, further comprising:
re-measuring the signal intensity of the selected network periodically after changing to the next-order network; and
changing from the next-order network to the selected network when the signal intensity of the user-selected network is equal to or greater than the preset value.

3. The method of claim 1, further comprising:
measuring the signal intensity of the next-order network after changing to the next-order network; and
changing to a network other than the next-order network from among the plurality of networks based on the priority information when the signal intensity of the next-order network is below the preset value.

4. The method of claim 1, wherein setting comprises setting priority information of the plurality of networks based on the network signal intensities.

5. The method of claim 1, wherein setting comprises re-measuring the signal intensity of the network periodically and changing the priority information, when the priority information is set to be network signal intensity information.

6. The method of claim 1, wherein setting comprises setting the priority information of the plurality of networks using at least one of network charge information, content-based network capacity and speed, and network use frequency.

7. The method of claim 1, wherein the plurality of networks comprises at least one of a wired network, a wireless network and a mobile network.

8. The method of claim 1, wherein changing further comprises displaying a message indicating a change to the next-order network.

9. A display apparatus, comprising:
input circuitry configured to receive information of a plurality of networks and to set priority information of the plurality of networks;
an intensity measuring circuit configured to measure signal intensity of a selected network, when a command to select one network from among the plurality of networks is received; and
a controller configured to change from the selected network to a next-order network from among the plurality of networks based on the priority information, when the measured signal intensity is below a preset value.

10. The display apparatus of claim 9, wherein, after changing to the next-order network, the controller is configured to control the intensity measuring circuit to re-measure the signal intensity of the selected network periodically, and when the signal intensity of the selected network is equal to or greater than the preset value, to change from the next-order network to the selected network.

11. The display apparatus of claim 9, wherein after changing to the next-order network, the controller is configured to control the intensity measuring circuit to measure the signal intensity of the next-order network, and when the signal intensity of the next-order network is below the preset value, to change to a network other than the next-order network from among the plurality of networks based on the priority information.

12. The display apparatus of claim 9, wherein the controller is configured to set the priority information of the plurality of networks based on the network signal intensities.

13. The display apparatus of claim 9, wherein the controller is configured to control the intensity measuring circuit to re-measure the signal intensity of the network periodically and to change the priority information, when the priority information is set to be network signal intensity information.

14. The display apparatus of claim 9, wherein the controller is configured to set the priority information of the plurality of networks using at least one of network charge information, content-based network capacity and speed, and user's network use frequency.

15. The display apparatus of claim 9, wherein the plurality of networks comprises at least one of a wired network, a wireless network and a mobile network.

16. The display apparatus of claim 9, further comprising a display configured to display a message indicating a change to the next-order network.
